(19) United States
(12) Patent Application Publication
(10) Pub. No.: US 2026/0326273 A1
(43) Pub. Date: Oct. 22, 2026

(54) ROTATING ARM TIGHTENING TOOLS

(71) Applicant: Atlas Copco Industrial Technique AB, Stockholm (SE)

(72) Inventor: Andrea LOCATELLI, Verderio (LC) (IT)

(21) Appl. No.: 18/880,804

(22) PCT Filed: Jul. 4, 2023
(86) PCT No.: PCT/IB2023/056932

§ 371 Date: Jan. 2, 2025

(30) Foreign Application Priority Data
Jul. 5, 2022 (IT) 102022000014182

(51) Int. Cl. B25B 23/142; B25B 23/00

(52) U.S. Cl. CPC B25B 23/1425; B25B 23/0007

(57) ABSTRACT

A tool may include: a body including first and second ends; a handle at the first end of the body; an arm including proximal and distal ends; and a connector configured to detachably connect the proximal end of the arm to the second end of the body. The distal end of the arm may include a seat configured to accept a plurality of inserts for engaging a mechanical member. The arm may further include one or more sensors configured to detect torque exerted on the mechanical member. The connector may be further configured to allow mechanical, power, and data connections between the arm and body. The connector may be further configured to allow the arm to be oriented, relative to the body, around a longitudinal axis of the tool to a plurality of predetermined positions in establishing and/or maintaining the power and data connections between the arm and body.

The present invention refers to an electronic tool for the controlled tightening of mechanical members; such tool can be for example a torque wrench in which it is possible to check the tightening torque exerted on the bolt to be tightened.

Tightening tools are known in the state of the art comprising a body, containing control circuits and an electronic processing unit with a handle for gripping by an operator performing the tightening at one end, and an arm at the other end. Said arm comprises at its free end a seat in which a plurality of inserts can be inserted suitable for engaging the tool with a corresponding type and/or dimension of a mechanical member on which the tool is intended to operate to carry out a tightening operation. Sensor means are provided on said arm suitable for detecting tightening conditions exerted on said mechanical member. From these sensor means, the signals are transferred to the central processing unit, which processes and simultaneously displays them, so that the tightening performed can be verified.

Patent EP2326464 describes a tool of this type in the form of a torque wrench, which comprises a body, containing the control circuits and processing unit of the wrench, at one end a handle (advantageously containing rechargeable batteries for powering the wrench) and on the other end an arm. Advantageously, a display for visualizing information and operating data is provided on the body and a keyboard allows data and commands to be entered. A tool head which must be coupled with the type of mechanical member (for example, the head of a screw, with male or female coupling) on which the wrench is intended to operate is inserted interchangeably in a special seat at the end of the arm.

The sensors which measure the torque to be exerted on the member to be tightened are placed on the arm and comprise at least one strain gauge, which is a sensor whose electrical resistance varies with the deformation it undergoes; so it converts the force, pressure, voltage, weight, etc., into a variation in electrical resistance that can be measured.

The value of the torque exerted is normally available on the wrench display or is indicated near it by means of special light and/or acoustic signals.

Patent application WO2021124182 describes such a tool in which the arm is equipped with a microcontroller electronic card, capable of digitizing sensor signals and transmitting them to the central unit in digital format. Further, the arm is removably connected to the body through a connector allowing both the mechanical connection and the transmission/reception of electrical and power supply signals between the two parts. In this way, the electrical energy is supplied to the microcontroller electronic card through the connector and the signals can transit digitally along the arm and pass to the body and be received by the central electronic unit.

The applicant noted that such a connector placed between the arm and the wrench constrains the arm itself to the wrench in a single predetermined position, as it must ensure both mechanical and electrical coupling.

As the tool head and arm also have a fixed operating position in relation to each other, in some cases it would be advantageous to be able to position the body and arm in a different orientation with respect to the longitudinal axis of the tool. In this way, the wrench display could be visible to the operator when holding the wrench in different orientations.

Further objects and advantages of the present invention will become clear from the following description and from the attached drawings, provided purely by way of non-limiting example, in which:

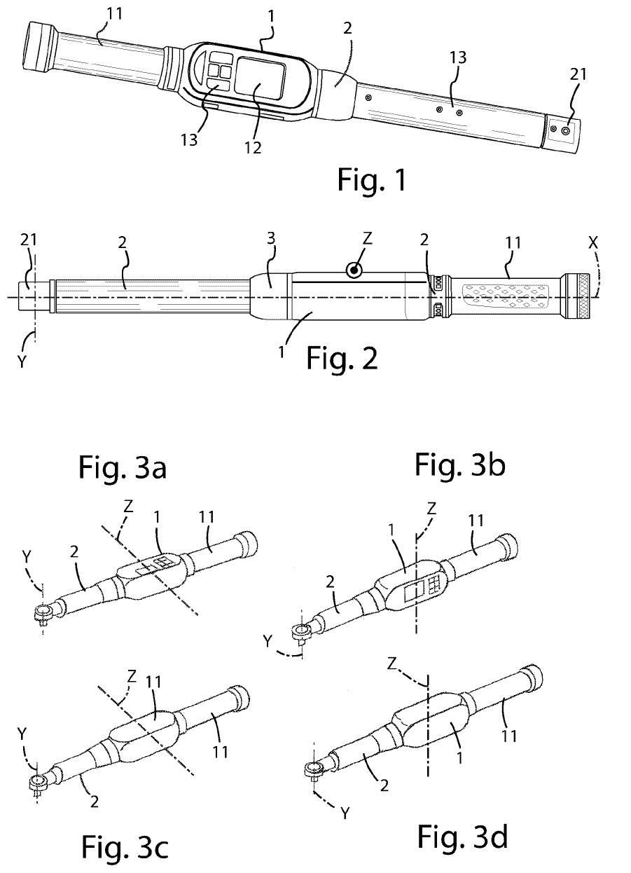

FIG. 1 is a perspective view of the tightening tool according to the present invention;

FIG. 2 is a front view of the tool of FIG. 1;

FIGS. 3a-3d illustrate four predetermined positions of constraint between the arm and body of the tool;

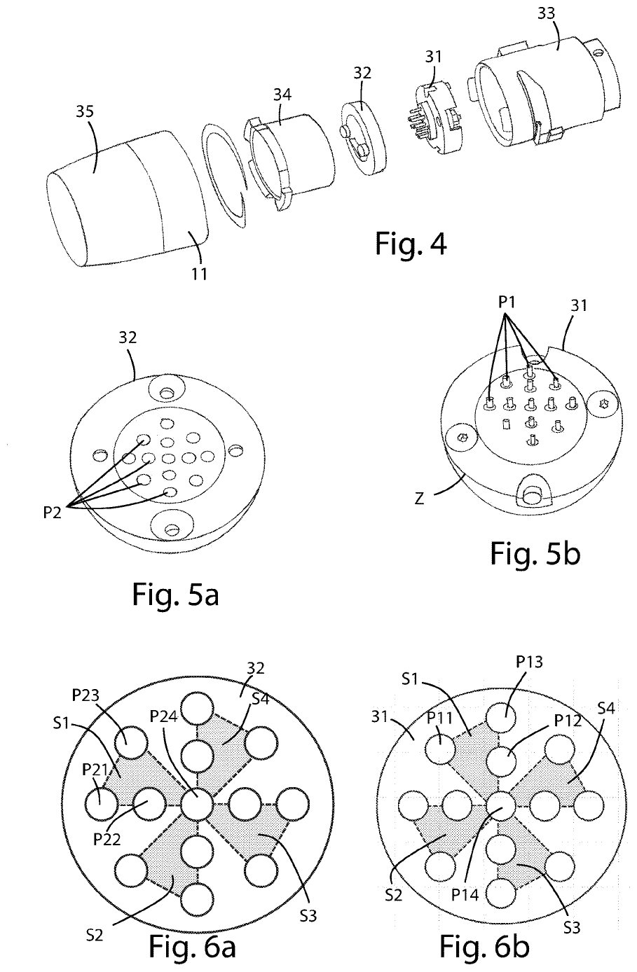

FIG. 4 shows an exploded view of the tool connector according to the present invention;

FIGS. 5a and 5b illustrate the arm and/or body interface of the connector in FIG. 4, respectively;

With reference to the aforementioned figures, the tightening tool according to the present invention is a torque wrench and comprises a body 1 containing electronic control circuits and a central processing unit having at one end of said body, along a longitudinal axis X of the tool, a handle 11 (preferably containing rechargeable batteries for powering the tool) and on the other end an arm 2, still on the same axis. Advantageously, a display 12 for visualizing information and operating data is provided on the body 1 and a keyboard 13 allows data and commands to be entered.

Naturally, it is understood that if the processing or storage of data requires a unit which cannot be easily or completely contained in the body 1, the body 1 can be connected, by means of a cable or a wireless connection, to external processing units. A wired connection can also be envisaged to provide external power supply.

A plurality of inserts can be alternatively pluggable in a suitable seat 21 at the end of the arm 2. For example, each insert will be suitable for engaging the wrench with a corresponding type and/or dimension of mechanical member or element (screw, nut, etc.) on which the tool is destined to operate.

Although for simplicity's sake inserts having all a similar dimension are shown, elongated inserts or inserts with arms of particular shape can also be provided, as known in the art.

Each insert may comprise internally a transponder in a suitable position (typically in the plugging shank to the seat 21) to be coupled to a suitable antenna close to the seat when it is mounted on the tool.

The manners for coupling between transponder and antenna for the activation of the transponder (usually known as “tag”) and the communication are widely known and will therefore not be described in detail here.

The tool comprises sensor means for detecting the tightening conditions, for example sensors for the torque exerted on the mechanical member, made with groups of strain gauges arranged in the arm and possibly angle sensors by means of a gyroscope for detecting the tightening angle.

Preferably, a microcontroller electronic card is provided on said arm suitable for receiving analog signals from the sensor means on the tightening conditions, converting them into digital format, possibly performing pre-processing and handling the transfer thereof in digital format to the central processing unit.

Examples of pre-processing may be filtering of the signal, detections of torque peaks, elimination of spurious data, analysis of linearity, angle/speed conversion, detection of the yield transducer status, management of the usage data and count of the tightening cycles.

This microprocessor electronic board is preferably powered by the tool's rechargeable batteries. Alternatively or in addition, this board has its own rechargeable batteries.

Advantageously, the arm 2 is removably connected to the body 1 through a connector 3 allowing both the mechanical connection and the transmission/reception of electrical and power supply signals between the two parts.

In this way, the electrical energy is supplied to the microprocessor electronic card through the connector and the signals can transit digitally along the arm and pass to the body and be received by the central electronic unit.

The fact that a first sensor processing takes place in the arm allows eventually to add further sensors whose signals in digital format can be transmitted together with the signals of the other sensors with no need to modify the tool, for which the expansion of the digital signal would be necessary. For example, a temperature and humidity sensor required by some regulations for calibrations might be added.

A mechatronic device capable of managing or simulating a click-wrench could be inserted into the arm. In addition, the wrench could be equipped with a sensor for geo-localization.

Advantageously, the sensor means and the electronic card are inserted in a single support inside the arm.

Furthermore, the possibility of storing information on the arm itself and also information relating to the tool head, which can then be transferred to the central electronic unit present on the body, favours the interchangeability of the arm itself. In fact, when an arm of the body is replaced with another one (for example having different dimensions), the information can be transferred directly to the central unit and the settings can be automatically modified if necessary, so that the measurement is automatically correct.

The connector 3, which constrains the arm to the tool body, allows the arm to be oriented around the longitudinal axis X of the tool with respect to the wrench body, so that a plurality of predetermined constraint and mechanical and electrical connection positions between the arm and the wrench body can be achieved.

For the purposes of the present invention, a predetermined tightening position means a position having a predetermined angle between the tightening axis Y of the tool head and the axis Z within the plane of the tool display 12.

In fact, in this way during tightening operations, in whatever position the element to be tightened (i.e. the bolt) is located, the operator, by rotating the tool body and engaging the arm of the tool body itself via the connector, can choose the most comfortable position that allows him to view the display and at the same time tighten effectively.

As illustrated in FIGS. 3a-3d preferably there are four predetermined positions equidistant to one other, i.e. where the tightening angle is 0°, 90°, 180° and 270°, respectively. As mentioned above, in any of these predetermined positions, both the electrical connection (i.e. power supply and/or data) and the stable mechanical connection between the arm and the tool body is guaranteed. For this purpose, the connector 3 comprises at the end of the body facing the arm a first disc-shaped interface 31 comprising a plurality of first electrical contacts P1, which is coupled with a corresponding second interface 32, also disc-shaped, provided with an equal number of second electrical contacts P2, which are connected with the first contacts P1; in each of the predetermined positions, the first electrical contacts P1 and the second electrical contacts P2, ensure the electrical connection between the arm and the tool body.

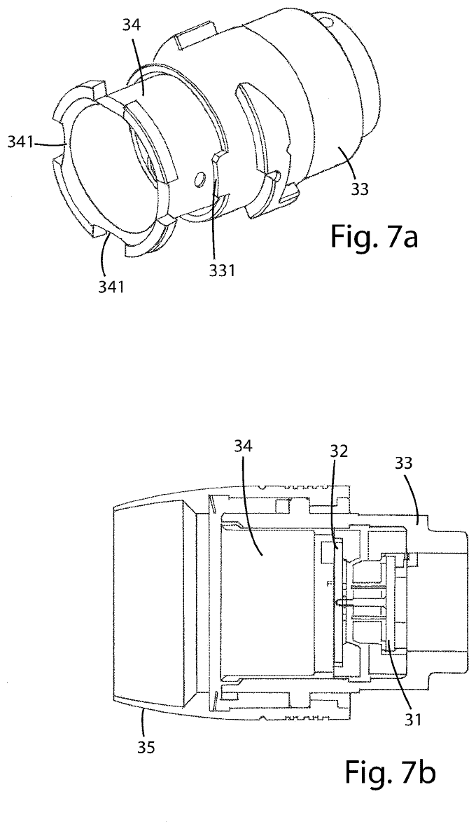

The electrical contacts (first P1 and second P2) are positioned on the interface following a pattern that repeats itself at predefined angles for a number of times corresponding to the predefined constraint positions between the arm and the body. For example, as illustrated in FIG. 6, where there are four predefined constraint positions arranged at 90° to one other, (forming the four tool configurations illustrated in FIGS. 3a-d), the pattern of four contacts P11-P14 and P21-P24, is repeated four times S1-S4. Each pattern comprises four contacts, as data and power supply are exchanged (bi-directionally RX and TX) between the arm and the tool body. Specifically, the central contact P14 (or P24 for interface 32) located in the centre of the disc-shaped interface 31 represents the positive supply contact (+supply), in all patterns S1-S4, while the other three reproduced in each pattern are respectively P13 (or P21 for interface 32) the ground contact (or—supply), P12 (or P22 for interface 32) the data transmission contact, P11 (or P23 for interface 32) the data reception contact.

For the purposes of the present invention, data transmission means in the arm-to-body direction.

The presence of the aforementioned 4 contact configurations on both sides (arm and body) constitutes a redundancy of connections for data signals (tx, rx, power-). This redundancy ensures greater robustness against micro-disconnections that may be caused by shocks and/or vibrations during use of the device. In fact, compared to a single configuration of contacts, disconnection would have to occur simultaneously on all 4 contacts (per signal) to cause an interruption of the data flow; this event would be far less likely.

The connector also comprises means for placing these interfaces in contact with each other in the aforementioned predetermined positions comprising a bush 33 which is associated with the arm termination and which accommodates the interface 31. This bush is fitted at one end with a pair of engagement teeth 331. Such positioning means also comprise a sleeve 34, which is associated with the termination of the body that is connected to the arm, which fits into the bush and comprises four 341 peripheral seats into which such teeth 331 of the bush fit.

According to the illustrated embodiment, there are two teeth arranged at 180° to each other and there are four seats, so that four engagement positions are defined, corresponding to the four predetermined constraint positions between the tool body and arm. Clearly, a predefined number of connection patterns S on the interfaces 31 and 32 and an equal number of teeth and seats can define more or less than four predefined constraint positions between the tool body and arm. The connector 3 is finally encased in a locking and covering case 35.

1. A tightening tool, comprising:
a body, comprising control circuits and an electronic processing unit, having at a first end a handle for gripping by an operator who performs a tightening operation, and at a second end, an arm;
wherein the arm, at a free end, comprises a seat in which a plurality of inserts, suitable for engaging the tool with a corresponding type and/or size of mechanical member on which the tool is intended to act, can be alternatively engaged to perform the tightening operation,
wherein on the arm there are sensor means configured to detect tightening conditions exerted on the mechanical member,
wherein the arm is detachably connected to the body using a connector which allows both mechanical connection and transmission/reception of electrical signals and power supply between the arm and body, and
wherein the connector which constrains the arm to the body of the tool allows the arm to be oriented around a longitudinal axis of the tool with respect to the body, so as to reach a plurality of predetermined restraining and mechanical and electrical connection positions between the arm and body.

2. The tool of claim 1, in which the predetermined positions are four equidistant from each other, that is, in which an angle between a tightening axis of a head of the tool and an axis included in a plane of a display of the tool is 0°, 90°, 180°, and 270° respectively.

3. The tool of claim 1, wherein the connector comprises, at the second end of the body, a first disc-shaped interface comprising a number of first electrical contacts, which couples with a corresponding second disc-shaped interface, provided with a same number of second electrical contacts which are connected with the first electrical contacts, and
wherein in each of the predetermined positions, the first electrical contacts and the second electrical contacts ensure the electrical connection between the arm and body.

4. The tool of claim 3, in which the first and second electrical contacts are on the respective first and second interfaces following a pattern that is repeated over predefined equal angles for a number of times corresponding to the predetermined positions between the arm and body.

5. The tool of claim 4, in which each pattern includes four electrical contacts.

6. The tool of claim 5, in which the first and second contacts in the center of the respective first and second interfaces represent contacts common to all of the patterns.

7. The tool of claim 3, wherein the connector comprises means for positioning the first and second interfaces in contact with each other in the predetermined positions, the means for positioning comprising a bush, associated with a termination of the arm and which receives the respective first or second interface, and a sleeve, associated with a termination of the body which is connected to the arm and which is inserted into the bush.

8. The tool of claim 7, wherein the sleeve comprises four peripheral seats in which engagement teeth of the bush are inserted.

9. The tool of claim 8, wherein there are two of the engagement teeth arranged at 180° with respect to each other so as to define four engagement positions corresponding to four predetermined positions between the arm and body.

10. The tool of claim 1, wherein the tool is a torque wrench.

11. A tool, comprising:
a body comprising first and second ends;
a handle at the first end of the body;
an arm comprising proximal and distal ends; and
a connector configured to detachably connect the proximal end of the arm to the second end of the body;
wherein the body, handle, and arm define a longitudinal axis of the tool,
wherein the body comprises control circuits and a first processing unit,
wherein the handle is configured to be gripped by an operator of the tool,
wherein the distal end of the arm comprises a seat configured to accept a plurality of inserts for engaging a mechanical member,
wherein the arm further comprises one or more sensors configured to detect torque exerted on the mechanical member,
wherein the connector is further configured to allow mechanical connection between the arm and body,
wherein the connector is further configured to allow power connection between the arm and body,
wherein the connector is further configured to allow data connection between the arm and body, and
wherein the connector is further configured to allow the arm to be oriented, relative to the body, around the longitudinal axis of the tool to a plurality of predetermined positions in establishing the power and data connections between the arm and body.

12. The tool of claim 11, wherein the torque is exerted on the mechanical member around a second axis that is perpendicular to the longitudinal axis of the tool.

13. The tool of claim 11, wherein the arm further comprises a second processing unit configured to provide data to the first processing unit.

14. The tool of claim 11, wherein the plurality of predetermined positions provides redundancy in establishing the power connection between the arm and body.

15. The tool of claim 11, wherein the plurality of predetermined positions provides redundancy in establishing the data connection between the arm and body.

16. A tool, comprising:
a body comprising first and second ends;
a handle at the first end of the body;
an arm comprising proximal and distal ends; and
a connector configured to detachably connect the proximal end of the arm to the second end of the body;
wherein the body, handle, and arm define a longitudinal axis of the tool,
wherein the body comprises control circuits and a first processing unit,
wherein the handle is configured to be gripped by an operator of the tool,
wherein the distal end of the arm comprises a seat configured to accept a plurality of inserts for engaging a mechanical member,
wherein the arm further comprises one or more sensors configured to detect torque exerted on the mechanical member,
wherein the connector is further configured to allow mechanical connection between the arm and body,
wherein the connector is further configured to allow power connection between the arm and body,
wherein the connector is further configured to allow data connection between the arm and body, and
wherein the connector is further configured to allow the arm to be oriented, relative to the body, around the longitudinal axis of the tool to a plurality of predetermined positions in maintaining the power and data connections between the arm and body.

17. The tool of claim 16, wherein the torque is exerted on the mechanical member around a second axis that is perpendicular to the longitudinal axis of the tool.

18. The tool of claim 16, wherein the arm further comprises a second processing unit configured to provide data to the first processing unit.

19. The tool of claim 16, wherein the plurality of predetermined positions provides redundancy in maintaining the power connection between the arm and body.

20. The tool of claim 16, wherein the plurality of predetermined positions provides redundancy in maintaining the data connection between the arm and body.
